(19) United States
(12) Patent Application Publication
(10) Pub. No.: US 2018/0039427 A1
(43) Pub. Date: Feb. 8, 2018

(54) REDUCING PROGRAMMING TIME OF MEMORY DEVICES USING DATA ENCODING

(71) Applicant: Nuvoton Technology Corporation, Hsin-chu (TW)

(72) Inventor: Yuval Kirschner, Even Yehuda (IL)

(21) Appl. No.: 15/230,499

(22) Filed: Aug. 8, 2016

(51) Int. Cl. G06F 3/06

(52) U.S. Cl. CPC G06F 3/0613; G06F 3/0629; G06F 3/0673

(57) ABSTRACT

An apparatus for data storage includes an interface for communicating with a memory, and encoding circuitry. The memory incurs a first bit-programming duration in programming a first bit value, and incurs a second bit-programming duration, longer than the first bit-programming duration, in programming a second bit value opposite from the first bit value. The encoding circuitry is configured to receive input data words for storage in the memory, to encode the input data words so as to produce respective encoded data words, wherein the encoded data words are (i) larger than the input data words by multiple bits, but (ii) are programmed in the memory with a shorter programming duration than the input data words, and to send the encoded data words via the interface for storage in the memory.

### FIELD OF THE INVENTION

The present invention relates generally to data storage, and particularly to methods and systems for reducing programming time of memory devices using data encoding.

### SUMMARY OF THE INVENTION

An embodiment of the present invention that is described herein provides an apparatus for data storage, including an interface for communicating with a memory, and encoding circuitry. The memory incurs a first bit-programming duration in programming a first bit value, and incurs a second bit-programming duration, longer than the first bit-programming duration, in programming a second bit value opposite from the first bit value. The encoding circuitry is configured to receive input data words for storage in the memory, to encode the input data words so as to produce respective encoded data words, wherein the encoded data words are (i) larger than the input data words by multiple bits, but (ii) are programmed in the memory with a shorter programming duration than the input data words, and to send the encoded data words via the interface for storage in the memory.

Typically, a total number of occurrences of the second bit value across all the encoded data words is larger than the total number of occurrences of the second bit value across all the input data words. In some embodiments, the encoded data words consist of a subset of 2^{N} M-bit words having a smallest number of occurrences of the second bit value, from among all 2^{M} possible M-bit words. In an embodiment, the encoding circuitry is further configured to receive via the interface one or more encoded data words that were read from the memory, and to decode the encoded data words so as to reconstruct the corresponding input data words.

There is additionally provided, in accordance with an embodiment of the present invention, a method for data storage, including receiving input data words for storage in a memory. The memory incurs a first bit-programming duration in programming a first bit value, and incurs a second bit-programming duration, longer than the first bit-programming duration, in programming a second bit value opposite from the first bit value. The input data words are encoded so as to produce respective encoded data words. The encoded data words are (i) larger than the respective input data words by multiple bits, but (ii) are programmed in the memory with a shorter programming duration than the input data words. The encoded data words are sent for storage in the memory.

There is further provided, in accordance with an embodiment of the present invention, a computer software product, the product including a tangible non-transitory computer-readable medium in which program instructions are stored, which instructions, when read by a processor, cause the processor to communicate with a memory that incurs a first bit-programming duration in programming a first bit value, and incurs a second bit-programming duration, longer than the first bit-programming duration, in programming a second bit value opposite from the first bit value, to receive input data words for storage in the memory, to encode the input data words so as to produce respective encoded data words, wherein the encoded data words are (i) larger than the input data words by multiple bits, but (ii) are programmed in the memory with a shorter programming duration than the input data words, and to send the encoded data words via the interface for storage in the memory.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a memory system, in accordance with an embodiment of the present invention;

FIG. 2 is a flow chart that schematically illustrates a method for designing an encoding scheme for a memory system, in accordance with an embodiment of the present invention; and

FIG. 3 is a table showing example performance of an encoding scheme for a memory system, in accordance with an embodiment of the present invention.

### DETAILED DESCRIPTION OF EMBODIMENTS

### Overview

In some types of memory devices, programming duration varies depending on the number of “1” bit values vs. the number of “0” bit values in the data. For example, in some One-Time Programmable (OTP) memory devices, the memory is programmed by default to all “0”s, and only “1” bit values have to be written to the memory. As a result, data having a large number of “1” bit values will take longer to program than data having a small number of “1” bit values.

Put more generally, in some types of memory, programming a certain bit value incurs a certain bit-programming duration, and programming the opposite bit value incurs a longer bit-programming duration. In the present context, the bit value that takes longer to program (e.g., “1” in the OTP example) is referred to herein as a “slow-programming bit value.” The opposite bit value (e.g., “0” in the OTP example) is referred to herein as a “fast-programming bit value.”

Embodiments of the present invention that are described herein provide improved methods and system for programming such memory devices. In some embodiments, a memory controller receives input data words for storage in a memory having a slow-programming bit value and a fast-programming bit value. The memory controller encodes each input data word so as to produce a respective encoded data word. The encoding scheme is designed such that, although each encoded data word is larger than the corresponding input data word by two or more bits, the number of slow-programming bit values to be programmed is actually reduced. The memory controller programs the memory with the encoded data words instead of the original input data words. As a result, programming duration is reduced.

In the disclosed embodiments, the total number of slow-programming bit values, across the set of possible encoded data words, is smaller than the total number of slow-programming bit values across the set of possible input data words. As such, reduction in programming duration is achieved on average, but not necessarily for each and every data word.

The number of bits in each input data word is denoted N, and the number of bits in each encoded data word is denoted M, wherein M−N≧2. In other words, the encoding operation increases the data word size by at least two bits. In an example embodiment, the set of encoded data words is designed by choosing, from among the 2^{M} possible M-bit words, a subset of 2^{N} M-bit words having the fewest slow-programming bit values. Other selection criteria are also possible, as long as the number of slow-programming bit values across the set of encoded data words is smaller than the number of slow-programming bit values across the set of input data words.

It is possible in principle to encode the input data words using only a single additional bit. For example, it is possible to invert the bits of any input data word that contains more “1” bit values than “0” bit values, and add a “polarity bit” that indicates whether the data word was inverted or not. The disclosed techniques, however, outperform such single-bit schemes significantly. For N=8, for example, the disclosed technique using M=10 reduces programming time by ˜24%. A comparable single-bit scheme that adds a 9^{th} bit to every 8-bit input data word achieves only ˜18.2% reduction in programming time. It can also be shown that the disclosed scheme with N=16 and M=18 (which adds 2 bits to every 16-bit input data word) outperforms a single-bit scheme that adds one bit to every 8-bit input data word, with exactly the same memory overhead (˜21.3% vs. ˜18.2% reduction in programming time).

Several examples of encoding schemes having M−N≧2, and the associated reductions in programming durations, are presented herein.

### System Description

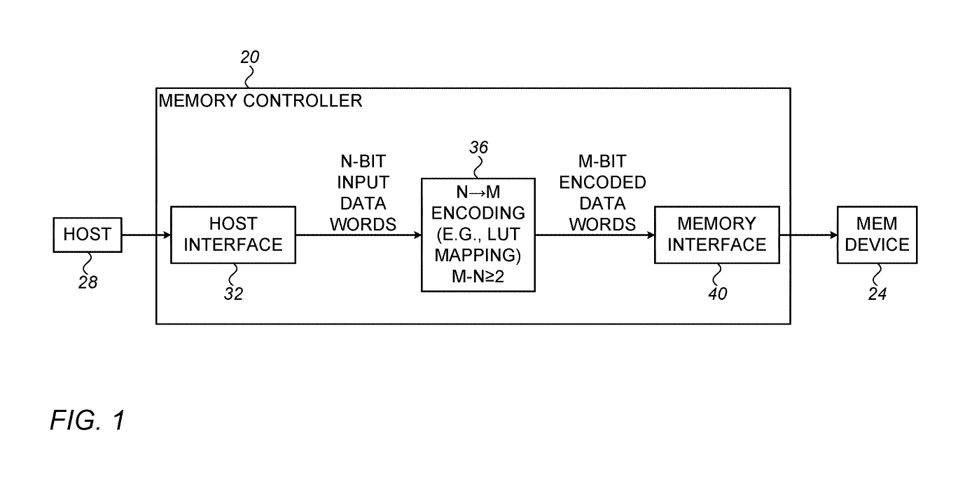

FIG. 1 is a block diagram that schematically illustrates a memory system, in accordance with an embodiment of the present invention. The memory system of FIG. 1 comprises a memory controller 20 that stores data in a memory device 24 on behalf of a host 28. In an example embodiment, the memory system may be part of a personal or mobile computer, in which case host 28 comprises a CPU chipset of the computer. Alternatively, the disclosed techniques may be used in various other applications and host systems.

Memory device 24 is characterized by data-dependent programming duration. Specifically, when storing data words that comprise multiple bits, programming a certain bit value incurs a certain bit-programming duration, and programming the opposite bit value incurs a longer bit-programming duration.

For example, in some embodiments memory device 24 comprises a One-Time Programmable (OTP) memory device that is initially programmed by default to all “0”s. In such a memory, only the “1” bit values have to be actually programmed. Therefore, data having a large number of “1” bit values will take longer to program than data having a small number of “1” bit values.

The bit value that takes longer to program (“1” in the present example) is referred to herein as a “slow-programming bit value,” and the opposite bit value (“0” in the present example) is referred to as a “fast-programming bit value.” Without loss of generality, the description that follows refers to “1” as the slow-programming bit value and to “0” as the fast-programming bit value, for the sake of clarity. Alternatively, however, in other types of memory “1” bit values may be faster to program than “0” bit values. The disclosed techniques can be adapted in a straightforward manner to such memory types. Thus, memory device 24 may comprise any suitable type of memory in which one bit value takes longer to program than the opposite bit value.

Memory controller 20 comprises a host interface 32 for communicating with host 28, a memory interface 40 for communicating with memory device 24, and encoding circuitry that is configured to encode the data words to be written into the memory device. In the embodiment of FIG. 1, the encoding circuitry comprises an encoder 36, which encodes input data words so as to produce encoded data words having shorter programming durations. Example encoding schemes are explained in detail below. In an example embodiment, encoder 36 comprises a Look-Up Table (LUT) that maps N-bit input data words to respective M-bit encoded data words, wherein M−N≧2. Such a LUT can be implemented, for example, in Read-Only Memory (ROM).

The memory system configuration shown in FIG. 1 is an example configuration that is depicted purely for the sake of conceptual clarity. In alternative embodiments, any other suitable configuration can be used. For example, the disclosed techniques can be used with other types of memory, e.g., some types of Flash memory. As another example, the encoding circuitry need not necessarily be part of a memory controller and may be, for example, implemented in the same device as memory device 24, or in host 28.

System elements that are not mandatory for understanding of the disclosed techniques have been omitted from the figure for the sake of clarity. For example, the encoding circuitry typically comprises a decoder (not shown), which reads encoded data words from memory device 24 and applies the reverse mapping so as to reconstruct the corresponding input data words.

In various embodiments, the different elements of the memory system, including the different elements of memory controller 20, may be implemented using any suitable hardware, such as in an Application-Specific Integrated Circuit (ASIC) or Field-Programmable Gate Array (FPGA). Alternatively, some of the memory controller functions, e.g., the encoding functionality of encoder 36, may be implemented in software running of a suitable processor, e.g., a processor in memory controller 20 or in host 28. In the latter embodiments, the processor may comprises a general-purpose processor, which is programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

### Encoding Schemes for Reduced Programming Duration

In some embodiments, encoder 36 receives N-bit input data words, and encodes each N-bit input data word by mapping it to a respective M-bit encoded data word, wherein M−N≧2. The mapping applied by encoder 36 is designed such that, although the encoded data words are larger than the input data words by two or more bits, the number of slow-programming bit values to be programmed is actually reduced.

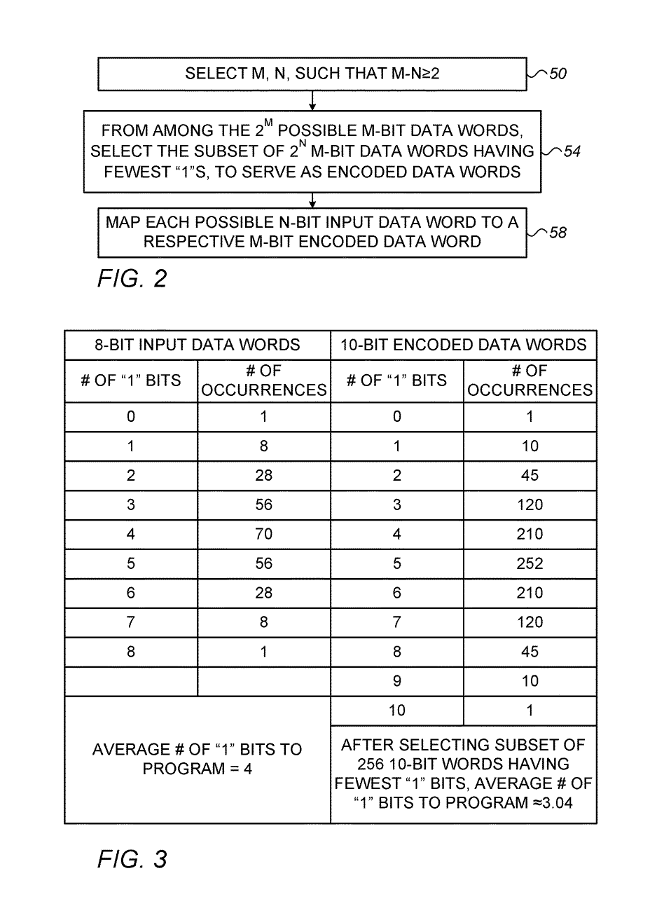

FIG. 2 is a flow chart that schematically illustrates a method for designing the encoding scheme applied by encoder 36, in accordance with an embodiment of the present invention. The method begins with choosing the values of M and N, such that M−N≧2, at a word-size selection step 50.

In some embodiments, although not necessarily, the value of N (the size of the input data words) is given, whereas the value of M (the size of the encoded data words) is a design choice, possibly subject to implementation constraints. In an example embodiment, N=8 and M=10. In another example embodiment, N=16 and M=18. The performance of both schemes is analyzed further below.

At a subset selection step 54, a subset of 2^{N} M-bit words is chosen from among the 2^{M} possible M-bit words, to serve as the set of encoded data words. In some embodiments, the subset is selected and the 2^{N} M-bit words having the fewest slow-programming bit values (in the present example, fewest “1” bit values).

At a mapping definition 58, each of the possible 2^{N} N-bit input data words is mapped to a respective M-bit encoded data word from the selected subset. Due to the way the subset is selected at step 54, programming the encoded data words to memory device 24 is faster than programming the original input data words (even though the encoded data words have more bits than the input data words).

In alternative embodiments, other selection criteria can be used for selecting the 2^{N} M-bit encoded data words from among the 2^{M} possible M-bit words. Generally, any selection criterion, which results in the number of slow-programming bit values across the set of encoded data words being smaller than the number of slow-programming bit values across the set of input data words, can be used. In other words, the set of encoded data words need not necessarily have the smallest possible number of slow-programming bit values. Any number that is smaller than the number of slow-programming bit values in the original input data words will reduce the average programming time. The selection of the set of encoded data words, and/or the mapping between input data words and encoded data words, may take into consideration additional factors, such as implementation complexity of the encoding and decoding operations.

FIG. 3 is a table showing example performance of an example encoding scheme, in accordance with an embodiment of the present invention. In the example of FIG. 3, N=8 and M=10.

The two left-hand-side columns of the table count the number of “1” bit values across the 2⁸=256 possible 8-bit input data words. As can be seen in the table, the full set of 256 possible input data words consists of 1 word having no “1” bit values, 8 words having one “1” bit value, 28 words having two “1” bit values, 56 words having three “1” bit values, and so on. Thus, the average number of “1” bit values per input data word is 4.

The two right-hand-side columns of the table count the number of “1” bit values across the 2¹⁰=1024 possible 10-bit words. As can be seen in the table, the full set of 1024 10-bit words consists of 1 word having no “1” bit values, 10 words having one “1” bit value, 45 words having two “1” bit values, 120 words having three “1” bit values, and so on.

In the present example, the subset of 256 10-bit words having the fewest “1” bit values is selected from among the 1024 possible 10-bit words. To reach a total of 256 words, the subset consists of all the 10-bit words having up to three “1” bit values (176 words in total), plus 80 of the 10-bit words having four “1” bit values. This subset is used as the set of 10-bit encoded data words. With this selection, the average number of “1” bit values per encoded data word is approximately 3.04.

In the present example, the disclosed encoding scheme reduces the average programming time by ˜24% (3.04 vs. 4), at the expense of additional 25% memory overhead. This trade-off is beneficial in many practical implementations.

In alternative embodiments, it is possible to set different trade-offs between programming time and memory overhead, by choosing N and/or M differently. For example, for N=8, an extreme trade-off can be set by choosing M=255. The subset of 256 255-bit encoded data words is the following: {0000000 . . . 00000}, {0000000 . . . 00001}, {0000000 . . . 00010}, {0000000 . . . 00100}, {0000000 . . . 01000}, . . . , {0100000 . . . 00000}, {1000000 . . . 00000}. Each encoded 255-bit encoded data word has at most one “1” bit value. In this example, the disclosed encoding scheme reduces the average programming time by 75%, but increases the memory overhead by a factor of ˜30.

In yet another extreme example, N=4 and M=15, and the subset of sixteen 15-bit encoded data words is the following: {00000 . . . 000}, {00000 . . . 001}, {00000 . . . 010}, {00000 . . . 100}, . . . , {01000 . . . 000}, {10000 . . . 000}. In this example, too, each 15-bit encoded data word has at most one “1” bit value. The disclosed encoding scheme reduces the average programming time by 50%, but increases the memory overhead by a factor of ˜3.75.

Further alternatively, the disclosed techniques can be carried out using any other suitable choice of N, M, any other suitable selection of the subset of encoded data words, and any suitable mapping between the input data words and the encoded data words.

Although the embodiments described herein mainly address reduction of programming time, the methods and systems described herein can also be used in other applications, such as for improving other performance measures of the memory or of the system as a whole. For example, if programming of one bit value consumes more power than programming of the opposite bit value, the disclosed techniques can be used for reducing power consumption.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. An apparatus for data storage, comprising:
an interface for communicating with a memory, wherein the memory incurs a first bit-programming duration in programming a first bit value, and incurs a second bit-programming duration, longer than the first bit-programming duration, in programming a second bit value opposite from the first bit value; and
encoding circuitry, which is configured to receive input data words for storage in the memory, to encode the input data words so as to produce respective encoded data words, wherein the encoded data words are (i) larger than the input data words by multiple bits, but (ii) are programmed in the memory with a shorter programming duration than the input data words, and to send the encoded data words via the interface for storage in the memory.

2. The apparatus according to claim 1, wherein a total number of occurrences of the second bit value across all the encoded data words is larger than the total number of occurrences of the second bit value across all the input data words.

3. The apparatus according to claim 1, wherein the encoded data words consist of a subset of 2^{N} M-bit words having a smallest number of occurrences of the second bit value, from among all 2^{M} possible M-bit words.

4. The apparatus according to claim 1, wherein the encoding circuitry is further configured to receive via the interface one or more encoded data words that were read from the memory, and to decode the encoded data words so as to reconstruct the corresponding input data words.

5. A method for data storage, comprising:
receiving input data words for storage in a memory, wherein the memory incurs a first bit-programming duration in programming a first bit value, and incurs a second bit-programming duration, longer than the first bit-programming duration, in programming a second bit value opposite from the first bit value;
encoding the input data words so as to produce respective encoded data words, wherein the encoded data words are (i) larger than the respective input data words by multiple bits, but (ii) are programmed in the memory with a shorter programming duration than the input data words; and
sending the encoded data words for storage in the memory.

6. The method according to claim 5, wherein a total number of occurrences of the second bit value across all the encoded data words is larger than the total number of occurrences of the second bit value across all the input data words.

7. The method according to claim 6, wherein the encoded data words consist of a subset of 2^{N} M-bit words having a smallest number of occurrences of the second bit value, from among all 2^{M} possible M-bit words.

8. The method according to claim 5, and further comprising receiving one or more encoded data words that were read from the memory, and decoding the encoded data words so as to reconstruct the corresponding input data words.

9. A computer software product, the product comprising a tangible non-transitory computer-readable medium in which program instructions are stored, which instructions, when read by a processor, cause the processor to communicate with a memory that incurs a first bit-programming duration in programming a first bit value, and incurs a second bit-programming duration, longer than the first bit-programming duration, in programming a second bit value opposite from the first bit value, to receive input data words for storage in the memory, to encode the input data words so as to produce respective encoded data words, wherein the encoded data words are (i) larger than the input data words by multiple bits, but (ii) are programmed in the memory with a shorter programming duration than the input data words, and to send the encoded data words via the interface for storage in the memory.

10. The product according to claim 9, wherein a total number of occurrences of the second bit value across all the encoded data words is larger than the total number of occurrences of the second bit value across all the input data words.

11. The product according to claim 9, wherein the encoded data words consist of a subset of 2^{N} M-bit words having a smallest number of occurrences of the second bit value, from among all 2^{M} possible M-bit words.

12. The product according to claim 9, wherein the instructions further cause the processor to receive one or more encoded data words that were read from the memory, and to decode the encoded data words so as to reconstruct the corresponding input data words.
